(19) United States
(12) Patent Application Publication
(10) Pub. No.: US 2016/0350827 A1
(43) Pub. Date: Dec. 1, 2016

(54) APPARATUS FOR SELLING 3D PRINTED JEWELRY AND OPERATING METHOD THEREFOR

(71) Applicant: Juyeon LEE, Norwood, NJ (US)

(72) Inventor: Juyeon LEE, Norwood, NJ (US)

(21) Appl. No.: 15/163,269

(22) Filed: May 24, 2016

(30) Foreign Application Priority Data
May 27, 2015 (KR) 10-2015-0073910

(51) Int. Cl. G06Q 30/06; G06Q 50/18; G06Q 30/02

(52) U.S. Cl. CPC G06Q 30/0621; G06Q 30/0643; G06Q 30/0273; G06Q 30/0625; G06Q 50/184; B33Y 40/00

(57) ABSTRACT

Disclosed are an apparatus and method for selling 3D printed jewelry. The apparatus for selling 3D printed jewelry includes a designer terminal configured to register jewelry designs, jewelry main materials, and jewelry components manufactured by a designer in a 3D jewelry head office server, a customer terminal configured to receive from a customer and transmit to the 3D jewelry head office server a jewelry design, a jewelry main material, and a jewelry component that the customer desires to purchase, the 3D jewelry head office server configured to transmit a jewelry design search window for searching for the jewelry designs, the jewelry main materials, and the jewelry components to the customer terminal and transmit 3D jewelry printer data used to perform 3D printing to a 3D jewelry franchisee server, and the 3D jewelry franchisee server configured to produce 3D jewelry by performing 3D printing according to the 3D jewelry printer data.

### BACKGROUND OF THE INVENTION

Field of the Invention

The present invention relates to an apparatus and method for selling three dimensional (3D) printed jewelry and, more particularly, to an apparatus and method for manufacturing jewelry having a design desired by a customer using a 3D printer and selling the jewelry.

Description of the Related Art

Conventionally, technologies for manufacture and sale of 3D printed jewelry have not been proposed but a description of general jewelry manufacturing and selling may be given as follows.

Most conventional jewelry has been manufactured through a process of manually creating an original product (or die and mold) and then manually assembling the manufactured product. Since a make-to-order scheme (much cost is consumed during individual mold work) is used, it takes much time and cost to sell jewelry.

In the case of online sales, it is almost impossible to manufacture a single piece of customized jewelry for the above reasons. In addition, although too many materials and components applied to jewelry are present, absence of standardized distinguishable materials and components is one reason for difficulty in manufacturing customized jewelry.

In the case of materials and components of jewelry, sizes and colors thereof as well as types thereof should be considered. However, there is no standardized work up to now, thereby making it impossible to manufacture customized jewelry.

One important thing is that there are limits in providing a jewelry design through a traditional made-to-order scheme. To meet different requirements according to each season, material, or country, sensibilities and capabilities of jewelry designers are needed and types and trends of jewelry designs provided by designers need to be diversified. However, it is not the case in reality.

In addition, jewelry sales, especially, online sales, undergo a complicated process such as returning a product if a customer is not satisfied with a design or color of the product received through a delivery service or if there are improvements in the product. Accordingly, much time and cost is needed.

### SUMMARY OF THE INVENTION

The present invention has been made in view of the above problems, and it is an object of the present invention to provide an apparatus and method for manufacturing and selling jewelry having a design desired by a customer through 3D printing. It is another object of the present invention to provide simultaneously performing purchase and sale of 3D printed jewelry of a desired design.

In accordance with the present invention, the above and other objects can be accomplished by the provision of an apparatus for selling three-dimensional (3D) jewelry printed using 3D printing, including a designer terminal configured to register jewelry designs, jewelry main materials, and jewelry components manufactured by a designer in a 3D jewelry head office server; a customer terminal configured to receive, from a customer, a jewelry design, a jewelry main material, and a jewelry component that the customer desires to purchase among the jewelry designs, the jewelry main materials, and the jewelry components registered in the 3D jewelry head office server and transmit the jewelry design, the jewelry main material, and the jewelry component selected by the customer to the 3D jewelry head office server; the 3D jewelry head office server configured to transmit a jewelry design search window for searching for the jewelry designs, the jewelry main materials, and the jewelry components registered by the designer to the customer terminal and transmit 3D jewelry printer data used to perform 3D printing using the jewelry design, the jewelry main material, and the jewelry component selected by the customer to a 3D jewelry franchisee server corresponding to a server of a franchisee; and the 3D jewelry franchisee server configured to produce 3D jewelry by performing 3D printing according to the 3D jewelry printer data received from the 3D jewelry head office server.

The 3D jewelry head office server may include a jewelry design database (DB) configured to register jewelry designs manufactured by designers, a jewelry material DB configured to register jewelry main materials and jewelry components used during 3D printing of jewelry designs, a search window generator configured to generate a jewelry design search window for searching for the jewelry designs, the jewelry main materials, and the jewelry components according to each category, provide the jewelry design search window to the customer terminal, and display an estimated jewelry design to which a jewelry design, a jewelry main material, and a jewelry component selected through the customer terminal are applied in the jewelry design search window, a 3D jewelry printer data storage configured to store 3D jewelry printer data used to 3D-print the estimated jewelry design to which the jewelry design, the jewelry main material, and the jewelry component selected through the customer terminal are applied, and a 3D jewelry printer data transmitter configured to transmit the 3D jewelry printer data to the 3D jewelry franchisee server selected by the customer.

The search window generator may display 3D designs manufactured by designers, who have paid an advertisement fee, in an advertisement field of the jewelry design search window.

The 3D jewelry printer data transmitter may transmit the 3D jewelry printer data to the customer terminal.

The jewelry main materials and the jewelry components provided in the jewelry design search window are allocated a standardized size per jewelry main material and jewelry component.

The 3D jewelry head office server may further include a cost settler configured to bill purchase costs of a jewelry design purchased by the customer and deposit some of the billed purchase costs in an account of a designer who has proposed a sold jewelry design.

The 3D jewelry head office server may further include a design editor tool provider configured to provide a design editor tool through which a jewelry design is changeable to the customer terminal.

The design editor tool provider may provide an edited jewelry design obtained by combining zones selected by different jewelry designs to the customer terminal.

The 3D jewelry printer data storage may receive the edited jewelry design changed through the design editor tool from the customer terminal and generate and store an edited 3D jewelry design file used to 3D-print the edited jewelry design, and the 3D jewelry printer data transmitter may transmit the edited 3D jewelry design file to the 3D jewelry franchisee server as the 3D jewelry printer data.

In accordance with an aspect of the present invention, the above and other objects can be accomplished by the provision of a method of selling 3D printed jewelry, including registering, by the designer terminal, jewelry designs, jewelry main materials, and jewelry components manufactured by designers in a 3D jewelry head office server; providing, by the 3D jewelry head office server, a jewelry design search window for searching for the jewelry designs, jewelry main materials, and jewelry components registered by the designer terminal to a customer terminal; selecting, by the customer terminal, a jewelry design, a jewelry main material, and a jewelry component to be purchased through the jewelry design search window and transmitting the selected design, main material, and component to the 3D jewelry head office server; generating, by the 3D jewelry head office server, 3D jewelry printer data used to perform 3D printing of an estimated jewelry design to which the selected jewelry design, jewelry main material, and jewelry component are applied and storing the 3D jewelry printer data; transmitting, by the 3D jewelry head office server, the 3D jewelry printer data to the 3D jewelry franchisee server corresponding to a server of a franchisee; and manufacturing, by the 3D jewelry franchisee server, 3D jewelry by performing 3D printing according to the 3D jewelry printer data received from the 3D jewelry head office server.

The selecting may include confirming manufacturing by providing an estimated jewelry design to which the selected jewelry design, jewelry main material, and jewelry component are applied to the customer terminal, and if manufacturing confirmation is acknowledged by the customer terminal, transmitting the selected jewelry design, jewelry main material, and jewelry component to the 3D jewelry head office server.

The providing may further include transmitting a design editor tool through which a jewelry design is changeable to the customer terminal.

The selecting may include transmitting a jewelry design edited through the design editor tool to the 3D jewelry head office server, wherein the storing may include receiving the jewelry design edited through the design editor tool from the customer terminal and storing an edited 3D jewelry design file used to 3D-print the edited jewelry design, and the transmitting the 3D jewelry printer data may include transmitting the edited 3D jewelry design file to the 3D jewelry franchisee server as the 3D jewelry printer data.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a configuration of an apparatus for selling 3D printed jewelry according to an embodiment of the present invention;

FIG. 2 is a block diagram a configuration of a 3D printed jewelry head office server according to an embodiment of the present invention;

FIG. 3 is a diagram illustrating a jewelry design search window according to an embodiment of the present invention; and

FIG. 4 is a flowchart illustrating a process of selling 3D jewelry according to an embodiment of the present invention.

### DETAILED DESCRIPTION OF THE INVENTION

Hereinafter, exemplary embodiments of the present invention will be described in detail with reference to the accompanying drawings so that the above and other aspects of the present invention will be easily understood and realized by those skilled in the art. The above and other objects, features and other advantages of the present invention will be more clearly understood from the following detailed description. In the following description, like reference numerals designate like elements although the elements are shown in different drawings.

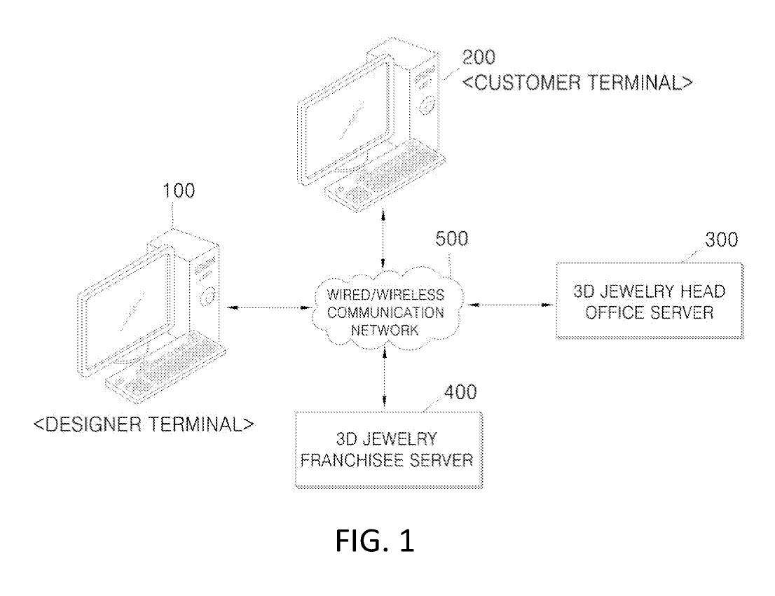

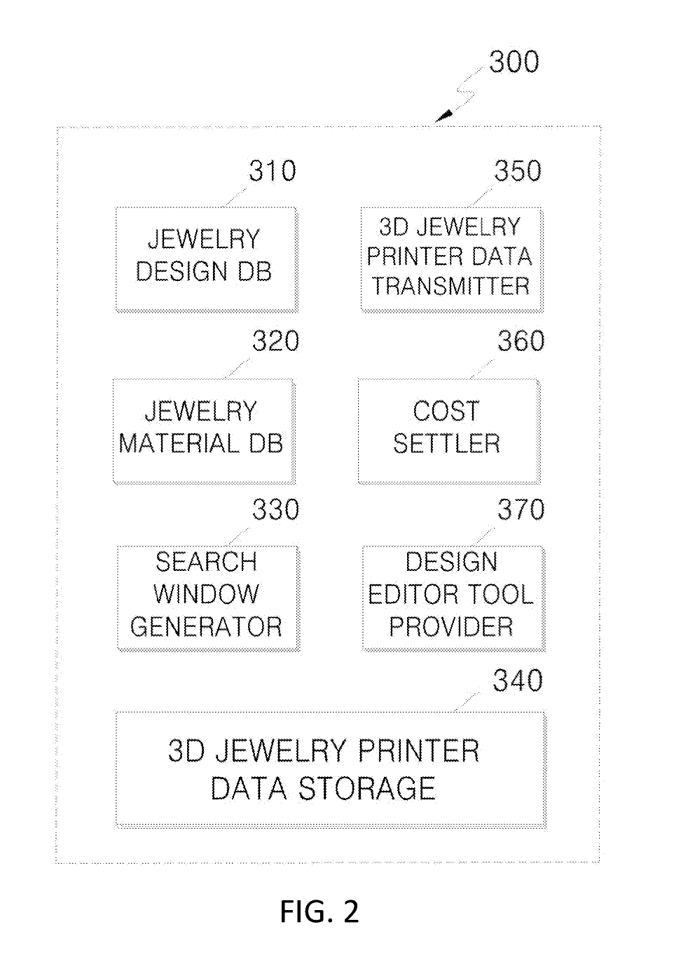

FIG. 1 is a diagram illustrating a configuration of an apparatus for selling 3D printed jewelry according to an embodiment of the present invention and FIG. 2 is a block diagram of a configuration of a 3D printed jewelry head office server according to an embodiment of the present invention.

Traditional jewelry sale has various problems in terms of cost, design, and efficiency because jewelry sale depends on mass production of small items or mass production of large items through a multi-level distribution structure between a producer and a customer. Accordingly, the present invention proposes online and offline business models incorporating 3D printing technology. That is, the business models of the present invention are differentiated from a conventional sale system in terms of cost, time, and efficiency through direction transaction between a producer and a customer. The present invention enables multi-item small scale production with a reasonable cost. In particular, since jewelry designed by any designer all over the world may be sold online, design trend may be immediately reflected and various types of designs may be supplied to the market.

To this end, the apparatus for selling 3D jewelry according to the present invention may include, as illustrated in FIG. 1, a wired/wireless communication network 500, a designer terminal 100, a customer terminal 200, a 3D jewelry head office server 300, and a 3D jewelry franchisee server 400.

Hereinafter, jewelry refers to items such as rings, necklaces, and earrings and includes various other types of accessories.

The wired/wireless communication network 500 is a network via which the designer terminal 100 registers jewelry designs in the 3D jewelry head office server 300, a network through which a search window of the 3D jewelry head office server 300 is provided to the customer terminal 200, or a network through which a jewelry design, a jewelry main material, and a jewelry component, selected by the customer terminal 200, are provided to the 3D jewelry head office server 300. If the wired/wireless communication network 500 is implemented by a wireless communication network, data communication may be performed using a wireless mobile communication network including a Base Transceiver Station (BTS), a Mobile Switching Center (MSC), and a Home Location Register (HLR). For reference, the wireless mobile communication network may further include elements, such as an access gateway and a Packet Data Serving Node (PDSN), for enabling transmission and reception of wireless packet data, in addition to the BTS, the MSC, and the HLR. If the wired/wireless communication network 500 is implemented by a wired communication network, data communication may be performed using a communication network according to a protocol such as Transmission Control Protocol/Internet Protocol (TCP/IP).

The designer terminal 100 is a terminal for registering jewelry designs, jewelry main materials, and jewelry components, designed by designers, in the 3D jewelry head office server 300. While the designer terminal 100 is described as a desktop PC in FIG. 1 by way of example, a smartphone, a tablet PC, a slate PC, a notebook computer, etc. as well as the desktop PC may be used as the designer terminal 100. It is apparent that the terminal to which the present invention is applicable is not limited to the above-described types and includes all terminals capable of performing communication with an external device. It is also apparent that the customer terminal 200, which will be described later, includes various terminals capable of communicating with an external device in addition to the desktop PC.

For reference, the smartphone refers to an intelligent terminal adding a computer support function such as Internet communication and information search to a cellular phone and a user may install a desired application in the smartphone. The smartphone has advantages of the cellular phone and a Personal Digital Assistant (PDA) and data communication functions such as schedule management, fax transmission and reception, and Internet access are incorporated into a portable phone function in the smartphone. The smartphone may directly access Internet using a wireless network and may also access Internet using various browsers in various manners. Unlike a conventional cellular phone, the smartphone may install, add, or delete hundreds of types of various applications (application programs) as a user wishes, so that an application desired by the user may be directly implemented through the smartphone or the user may achieve an interface suitable therefor through various applications of the smartphone.

Accordingly, each designer may install an application provided by the 3D jewelry head office server 300 (hereinafter, a “designer application”) in the designer terminal 100 thereof and register jewelry designs, jewelry main materials, and jewelry components manufactured thereby in the 3D jewelry head office server 300 using the installed designer application.

The customer terminal 200 receives a jewelry design, a jewelry main material, and a jewelry component that a customer desires to purchase among the jewelry designs, jewelry main materials, and jewelry components registered in the 3D jewelry head office server 300 from the customer and transmits the jewelry design, the jewelry main material, and the jewelry component selected by the customer to the 3D jewelry head office server 300. Likewise, the customer may install the application provided by the 3D jewelry head office server 300 (hereinafter, a “customer application”) in the customer terminal 200 to browse through a plurality of jewelry designs, jewelry materials, and jewelry components and then to select a desired jewelry design, jewelry material, and jewelry component and transmits the selected jewelry design, jewelry material, and jewelry component to the 3D jewelry head office server 300 through the customer terminal 200. Therefore, the customer may easily search for and select a desired jewelry design, material, and component through the customer terminal 200.

The 3D jewelry franchisee server 400 controls a 3D printer installed in a franchisee as a server managed by a franchisee supported by a 3D jewelry head office. Therefore, the 3D jewelry franchisee server 400 controls a 3D printer installed in a franchisee to perform 3D printing according to data for 3D jewelry printing (hereinafter, 3D jewelry printer data) received from the 3D jewelry head office server 300 and generates a 3D printed product. Since jewelry design using existing Photoshop, Illustrator, etc. cannot be immediately manufactured by the 3D printer, the 3D jewelry head office server 300 generates the 3D jewelry printer data using a program so that the 3D jewelry franchisee server 400 receives the 3D jewelry printer data and generates 3D printed jewelry using the 3D printer installed therein. Accordingly, a customer can purchase the 3D printed jewelry having a design selected thereby as a physical product by visiting the 3D jewelry franchisee server 400.

For reference, after the 3D jewelry franchisee server 400 prints 3D jewelry, a jewelry component, such as pearls (freshwater pearls, cultured pearls, plastic pearls, etc.), glasses (glass stone, glass beads, etc.), chains (steel chain, aluminum chain, etc.), leather (cow leather, cattle leather, artificial leather, etc.), gemstones, or acrylic, may be manually combined as ornaments. Alternatively, if the jewelry component can be manufactured by 3D printing, the jewelry component may be manufactured by 3D printing and then may be additionally combined into 3D printed jewelry by manual work.

The 3D jewelry head office server 300 generates a jewelry design search window for searching for jewelry designs, jewelry main materials, and jewelry components, registered by designers, and transmits the jewelry design search window to the customer terminal 200. If a customer selects a specific jewelry design, jewelry main material, and jewelry component through the customer terminal 200, the 3D jewelry head office server 300 generates and stores 3D jewelry printer data used to perform 3D printing using the jewelry design, jewelry main material, and jewelry component selected through the customer terminal 200 and transmits the generated 3D jewelry printer data to the 3D jewelry franchisee server 400, which is a server of a franchisee.

To implement the above operation, the 3D jewelry head office server 300 has the same hardware configuration as a typical web server and includes a program module having various functions in software through various languages such as C, C++, Java, Visual Basic, Visual C, etc. In addition, the program module may be implemented using a web server program, which is variously provided according to an operating system such as DOS, Windows, Linux, Unix, Macintosh, etc., in general server hardware and may use, as representative examples, website and Internet Information Server (IIS) used in a Windows environment and CERN, NCSA, and Apache used in a Unix environment.

The 3D jewelry head office server 300 may include, as illustrated in FIG. 2, a jewelry design database (DB) 310, a jewelry material DB 320, a search window generator 330, a 3D jewelry printer data storage 340, and a 3D jewelry printer data transmitter 350. The 3D jewelry head office server 300 may further include a cost settler 360, and a design editor tool provider 370.

The jewelry design DB 310 is a DB in which jewelry designs created by designers are registered. Designers have their own unique jewelry designs and the jewelry design DB 310 stores the jewelry designs registered by the designers. Any designer from anywhere around the world may request design registration by accessing an online site through the designer terminal 100 and a determination as to whether the designs can be registered may be made as soon as possible through examination of the registration requested designs. For reference, the jewelry design DB 310 may be included inside the apparatus as a module capable of inputting and outputting information, such as a hard disk drive, a Solid State Drive (SSD), a flash memory, a Compact Flash (CF) card, a Secure Digital (SD) card, a Smart Media (SM) card, a Multimedia Card (MMC), or a memory stick or may be included in a separate device.

The jewelry material DB 320 is a DB in which jewelry main materials and jewelry components used during 3D printing of jewelry designs are registered. A jewelry main material refers to a material of a body forming jewelry manufactured by 3D printing. The jewelry main material for 3D printing may be metal. Some materials of acryl/homaica series (of which ABS resin is raw material) may be the jewelry component material or the jewelry main material. Herein, metal includes aluminum, brass, silver, etc.

A jewelry component refers to a component coupled to a basic jewelry design and may be, for example, a hexagon of a sapphire shape coupled to the top of a ring. While jewelry composed of metal is a type in which various jewelry components have been basically assembled, various jewelry components are generally combined with metal.

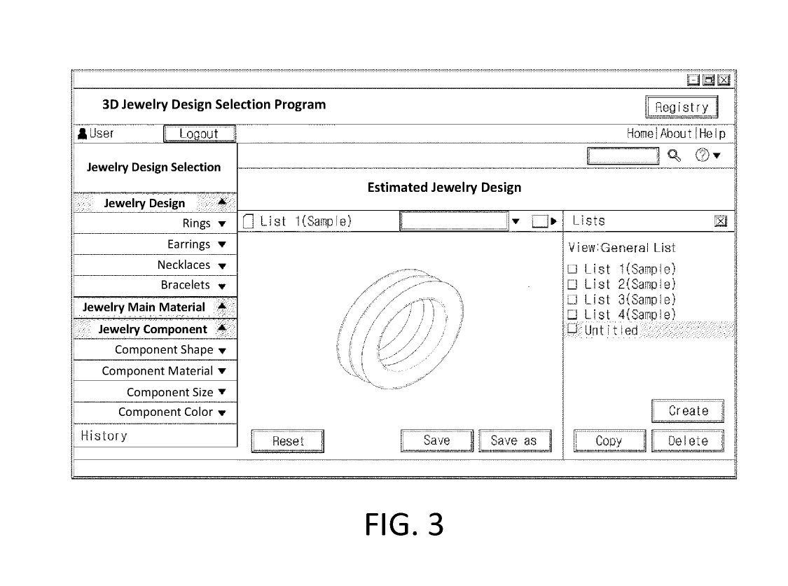

The search window generator 330 generates a jewelry design search window for searching for jewelry designs, jewelry main materials, and jewelry components according to each category and provides the jewelry design search window to the customer terminal 200. For example, as illustrated in FIG. 3, the search window generator 330 may include a jewelry design selection field for selecting a jewelry design, a jewelry main material selection field for selecting a jewelry main material, and a jewelry component selection field for selecting a jewelry component. Jewelry components provided in the jewelry design search window are provided as a standardized size per jewelry component. Currently, there are hundreds of thousands of jewelry components in consideration of color. In the present invention, components preferred by customers are standardized and provided through the jewelry design search window, thereby allowing customers to easily decide what to purchase.

For example, although the following types of jewelry main materials require various colors and sizes, the jewelry main materials may be standardized as follows so as to raise understanding of customers through standardization.
Shape of jewelry main material

Round, oval, tear drop, marquise, heart, rectangular, etc.
Size of jewelry main material

Round: 6 mm, 8 mm, 10 mm, 12 mm, 15 mm, 20 mm, etc.

Oval: 4×6 mm, 6×8 mm, 6×10 mm, 10×12 mm, etc.

Marquise: 4×6 mm, 6×8 mm, 6×10 mm, 10×12 mm, etc.

Rectangular: 6×8 mm, 8×10 mm, 10×12 mm, 12×15 mm, 15×20 mm, etc.
Type of jewelry main material

Zinc, tin, brass, steel, etc.
Color of jewelry main material

Gold, silver, copper, plating, etc.

The search window generator 330 displays, in the jewelry design search window, an estimated jewelry design to which a jewelry design, a jewelry main material, and a jewelry component selected through the customer terminal 200 are applied. For reference, an estimated jewelry design display field on which the estimated jewelry design is displayed is illustrated in FIG. 3. That is, a customer may see an estimated final design through the estimated jewelry design display field before final purchase confirmation after selecting a desired design, main material, and component. If the customer finally confirms an estimated jewelry design displayed on the estimated jewelry design display field, the selected jewelry design, jewelry main material, and jewelry component are transmitted to the 3D jewelry head office server 300.

In addition, the search window generator 330 may display 3D designs manufactured by designers, who have paid an advertisement fee, in an advertisement field (not shown) of the jewelry design search window. If an unspecified designer pays a predetermined fee to a head office in order to upload their designs, the head office permits the designer to use a separate exposed space of an online specific part for a certain period of time.

The 3D jewelry printer data storage 340 stores 3D jewelry printer data used to 3D-print an estimated jewelry design to which a jewelry design, jewelry main material, and jewelry component selected through the customer terminal 200 are applied. That is, if the jewelry design, jewelry main material, and jewelry component selected through the customer terminal 200 are transmitted to the 3D jewelry head office server 300, the 3D jewelry head office server 300 generates and store the 3D jewelry printer data of the estimated jewelry design to which the selected jewelry design, jewelry main material, and jewelry component are applied. Since jewelry design using existing Photoshop, Illustrator, etc. cannot be immediately manufactured by a 3D printer, the 3D jewelry head office server 300 generates and stores designs in online as the 3D jewelry printer data using a program so as to perform 3D printing of the designs.

The 3D jewelry printer data is generated and stored in various manners. For example, a 3D data expert manually generates the 3D jewelry printer data based on an estimated jewelry design to which the jewelry design, jewelry main material, and jewelry component selected through the customer terminal 200 are applied and the generated 3D jewelry printer data may be stored. Alternatively, if preallocated 3D printing design data is present for the selected jewelry design and 3D printing component data is present for the selected jewelry component, the 3D jewelry printer data may be combined with the prepared 3D printing design data and 3D printing component data and the combined 3D jewelry printer data may be generated and stored.

For reference, the 3D jewelry printer data is source data for 3D printing, for example Standard Triangulated Language (STL) data.

While 2D printer moves in forward and backward directions (x-axis) and in leftward and rightward (y-axis), a 3D printer produces a 3D object based on 3D jewelry printer data which is a 3D drawing adding upward and downward movements (z axis) to the above movements. The 3D drawing may generate the 3D jewelry printer data (STL data) using 3D Computer Aided Design (CAD), a 3D modeling program, or a 3D scanner.

The 3D jewelry printer data may be generated using the 3D CAD, the 3D modeling program, or the 3D scanner and may be produced through a shape data composition process, a shape data editing process, and a component type definition process as known in the art.

The shape data composition process includes extracting a 3D shape of a target object and composing 3D shape data. The 3D shape data is produced using 3D CAD, the 3D modeling program, or the 3D scanner. The 3D shape data is reserved in the form of, for example, STL data by performing adjustment of a patch plane direction, deletion of an unnecessary shell, filling of a gap, thinning of a patch, or smoothing of an outer shape.

Next, the shape data editing process includes editing the 3D shape data composed by a modeling function. In this case, the modeling function is provided by 3D image CAD software which is commercially available and includes composition of a cross sectional shape (including a partial cross sectional shape), composition of a plane, curved, or primitive shape, shape cut, addition of a symbol or a character, or addition of a marker.

The material type definition process includes defining a material type used in a model material. If resin is used, the model material may be selected from various types of resin capable of controlling parameters such as color, light transmittance, high degree of softness, X-ray transmittance, sensitivity of ultrasound, sensitivity of scintillation, sensitivity of a thermal line, or conductivity. In addition, a support material may be used as a 3D model material. If two types of resin can be simultaneously injected as the model material, the two types of resin may be selected and a mixing ratio of the resin (e.g., resin A:resin B=1:3) may be defined.

In addition, a 3D information file may include at least one of a model name of a product to which a 3D printing object manufactured through 3D jewelry printer data is to be applied, a type of the product to which the 3D printing object is to be applied, a real picture of the 3D printing object, and a registration shape image which is a shape image of the product to which the 3D printing object manufactured through the 3D jewelry printer data is to be applied.

The 3D jewelry printer data transmitter 350 transmits the 3D jewelry printer data to the 3D jewelry franchisee server 400 selected by a customer. Therefore, the 3D jewelry franchisee server 400 controls a 3D printer installed in a franchisee, performs 3D printing according to the 3D jewelry printer data received from the 3D jewelry head office server 300, and generate a physical object of 3D jewelry. Since jewelry design using existing Photoshop, Illustrator, etc. cannot be immediately manufactured by the 3D printer, the 3D jewelry head office server 300 generates the 3D jewelry printer data using a program so that the 3D jewelry franchisee server 400 receives the 3D jewelry printer data and produces 3D printed jewelry using the 3D printer installed therein. Accordingly, the customer may visit the 3D jewelry franchisee server 400, pay a bill, and purchase 3D jewelry having a design selected thereby.

Consequently, the customer makes a final purchase determination through determination of a jewelry design, a jewelry main material, and a jewelry component and, if purchase is determined, the customer may designate a desired franchisee (or store) and determine a product pick-up date and time or request that 3D jewelry be directly delivered to a desired place.

Billing may use all currently available general billing methods including online credit card billing, bank account transfer, and mobile billing. If billing is successfully completed, the 3D jewelry head office server 300 and the 3D jewelry franchisee server 400 of a corresponding franchisee are immediately informed of a customer purchase behavior through an online service. Then the franchisee (store) confirms stock of components (materials) used for a product purchased by the customer and outputs the product using the 3D printer. After the product is output, necessary assembly and treatment are performed prior to product pick-up by the customer and the product is reserved in a packed state. If the customer visits the franchisee, the product is transferred to the customer.

In addition, the 3D jewelry printer data transmitter 350 may transmit the 3D jewelry printer data to the customer terminal 200. This causes the customer to perform 3D printing for 3D jewelry using a 3D printer in a house of the customer by transmitting the 3D jewelry printer data to the customer who has paid a bill.

Meanwhile, the 3D jewelry head office server 300 may include the cost settler 360. The cost settler 360 settles purchase costs of a jewelry design purchased by the customer and deposits some of the billed purchase costs in an account of a designer who has proposed a sold jewelry design. If a customer purchases a design of a designer, a certain amount of money per design is accumulated in a virtual account of the designer as an incentive and, if the account balance exceeds a predetermined amount, the account balance is transferred to the designer through a method such transfer between accounts.

Meanwhile, if the customer desires to change a jewelry design, the customer may propose the changed jewelry design. Then, the 3D jewelry head office server 300 approves the changed jewelry design to provide customized jewelry. This serves to improve customer satisfaction by causing the customer to change a part of the jewelry design instead of total change of the jewelry design.

To this end, the 3D jewelry head office server 300 may further include the design editor tool provider 370. The design editor tool provider 370 provides a design editor tool through which a jewelry design can be changed to the customer terminal 200. The design editor tool may provide various design editing means. For example, if a basic ring design is a circle, the design editor tool may provide a means for editing a curvature of a partial zone of the circular ring or a means for editing only a partial zone of the circular ring to a linear type.

The customer may configure a new finished product by partially combining various designs. To this end, the design editor tool 370 may provide an edited jewelry design obtained by combining zones selected from different jewelry designs to the customer terminal 200. For example, if the customer selects a left region of a first jewelry design and selects a right region of a second jewelry design, the design editor tool 370 may generate the edited jewelry design by combining the left region of the first jewelry design and the right region of the second jewelry design and then provide the edited jewelry design to the customer terminal 200 so that the customer can confirm the edited jewelry design.

In this case, if the jewelry design is changed as described above, the edited design may be set such that customers cannot exchange the edited design or the edited design cannot be refunded.

Meanwhile, if the jewelry design is changed, the 3D jewelry printer data storage 340 receives the edited jewelry design changed through the design editor tool and a jewelry component from the customer terminal 200 and generates and stores an edited 3D jewelry design file used to 3D-print the edited jewelry design.

Accordingly, the 3D jewelry printer data transmitter 350 transmits the edited 3D jewelry design file to the jewelry franchisee server 400 as the 3D jewelry printer data. Then, the 3D jewelry franchisee server 400 performs 3D printing based on the edited 3D jewelry design file, thereby completing 3D jewelry. Therefore, the customer can purchase a product having a design edited thereby.

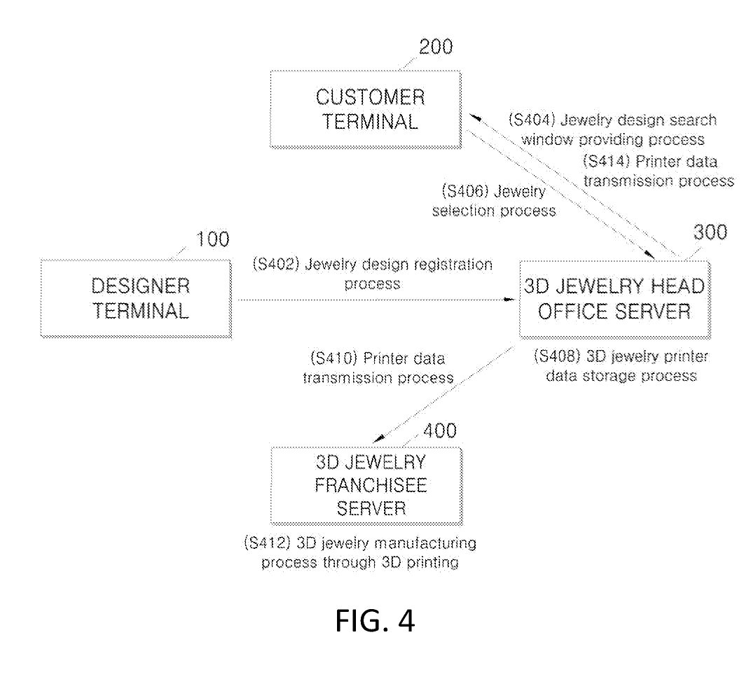

FIG. 4 is a flowchart illustrating a process of selling 3D jewelry according to an embodiment of the present invention.

A designer terminal 100 registers jewelry designs, jewelry main materials, and jewelry components manufactured by designers in a 3D jewelry head office server 300 (S402).

The 3D jewelry head office server 300 provides a jewelry design search window for searching for jewelry designs, jewelry main materials, and jewelry components registered by the designer terminal 100 to a customer terminal 200 (S404). For example, as illustrated in FIG. 3, the jewelry design search window may include a jewelry design selection field for selecting jewelry designs, a jewelry main material selection field for selecting jewelry main materials, and a jewelry component selection field for selecting jewelry components, through a search operation. The jewelry main material selection field and the jewelry component selection field provided in the jewelry design search window are allocated a standardized size per jewelry main material and jewelry component. Currently, there are hundreds of thousands of jewelry components and materials in consideration of color. In the present invention, components preferred by customers are standardized and provided through the jewelry design search window, thereby allowing customers to easily decide purchase.

The customer terminal 200 selects a jewelry design, a jewelry main material, and a jewelry component to be purchased through the jewelry design search window and transmits the selected design, main material, and component to the 3D jewelry head office server 300 (S406). In this case, the jewelry selection process includes confirming manufacturing by providing an estimated jewelry design to which the selected jewelry design, jewelry main material, and jewelry component are applied to the customer terminal 200. If manufacturing confirmation is acknowledged by the customer terminal 200, the customer terminal 200 transmits the selected jewelry design, jewelry main material, and jewelry component to the 3D jewelry head office server 300.

The 3D jewelry head office server 300 generates 3D jewelry printer data used to perform 3D printing of the estimated jewelry design to which the selected jewelry design, jewelry main material, and jewelry component are applied and stores the 3D jewelry printer data (S408).

The 3D jewelry head office server 300 transmits the 3D jewelry printer data to the 3D jewelry franchisee server 400 corresponding to a server of a franchisee (S410).

The 3D jewelry franchisee server 400 manufactures 3D jewelry by performing 3D printing according to the 3D jewelry printer data received from the 3D jewelry head office server 300 (S412). After, the 3D jewelry is manufactured, a jewelry component may be manually combined with the 3D jewelry. A customer may visit the 3D jewelry franchisee server 400, pay a bill, and purchase 3D jewelry having a design selected thereby as a physical object. Consequently, the customer makes a final purchase determination through selection of a jewelry design and determination of a jewelry main material and a jewelry component and, if purchase is determined, the customer may designate a desired franchisee (or store) and determine a product pick-up date and time or request that 3D jewelry be directly delivered to a desired place.

Meanwhile, if the customer desires to change the jewelry design, the customer may propose the changed jewelry design. Then, the 3D jewelry head office server 300 approves the changed jewelry design to provide customized jewelry. This serves to improve customer satisfaction by causing the customer to change a part of the jewelry design instead of total change of the jewelry design.

To this end, the jewelry design search window providing process S404 may further include transmitting a design editor tool through which the jewelry design can be changed to the customer terminal 200.

Therefore, if the jewelry design is changed, the jewelry selection process S406 includes transmitting a jewelry design edited through the design editor tool to the 3D jewelry head office server 300.

In addition, when the jewelry design is changed, the 3D jewelry printer data storage process S408 includes receiving the jewelry design edited through the design editor tool from the customer terminal 200 and storing an edited 3D jewelry design file used to 3D-print the edited jewelry design.

Furthermore, when the jewelry design is changed, the 3D jewelry printer data transmission process S410 includes transmitting the edited 3D jewelry design file to the 3D jewelry franchisee server 400 as the 3D jewelry printer data. Accordingly, the 3D jewelry franchisee server 400 performs 3D printing based on the jewelry 3D editing design file, thereby manufacturing the 3D jewelry (S412). As a result, the customer can purchase a product having a design edited thereby.

Meanwhile, the 3D jewelry printer data may be transmitted to the customer terminal 200. This causes the customer to perform 3D printing for 3D jewelry using a 3D printer in a house of the customer by transmitting the 3D jewelry printer data to the customer who has paid a bill. That is, the customer may receive jewelry at a franchisee or at a designated delivery place. In addition, the jewelry printer data may be transmitted to the customer terminal 200 to permit the customer to perform 3D printing only once when jewelry that does not require a subsidiary material and the customer has a 3D printer.

According to the embodiments of the present invention, purchase of 3D printed jewelry of a desired design and sale of 3D printed jewelry are simultaneously performed, thereby increasing sales. In addition, since jewelry designed by a customer can be manufactured using a 3D printer without adding a mold manufacturing cost, cost of manufacturing jewelry can be reduced.

Although exemplary embodiments of the present invention have been described for illustrative purposes, those skilled in the art will appreciate that various modifications, additions, and substitutions are possible, without departing from the scope and spirit of the present invention

What is claimed is:

1. An apparatus for selling three-dimensional (3D) jewelry printed using 3D printing, comprising:
a designer terminal configured to register jewelry designs, jewelry main materials, and jewelry components manufactured by a designer in a 3D jewelry head office server;
a customer terminal configured to receive, from a customer, a jewelry design, a jewelry main material, and a jewelry component that the customer desires to purchase among the jewelry designs, the jewelry main materials, and the jewelry components registered in the 3D jewelry head office server and transmit the jewelry design, the jewelry main material, and the jewelry component selected by the customer to the 3D jewelry head office server;
the 3D jewelry head office server configured to transmit a jewelry design search window for searching for the jewelry designs, the jewelry main materials, and the jewelry components registered by the designer to the customer terminal and transmit 3D jewelry printer data used to perform 3D printing using the jewelry design, the jewelry main material, and the jewelry component selected by the customer to a 3D jewelry franchisee server corresponding to a server of a franchisee; and
the 3D jewelry franchisee server configured to produce 3D jewelry by performing 3D printing according to the 3D jewelry printer data received from the 3D jewelry head office server,
wherein the 3D jewelry head office server includes
a jewelry design database (DB) configured to register jewelry designs manufactured by designers,
a jewelry material DB configured to register jewelry main materials and jewelry components used during 3D printing of jewelry designs,
a search window generator configured to generate a jewelry design search window for searching for the jewelry designs, the jewelry main materials, and the jewelry components according to each category, provide the jewelry design search window to the customer terminal, and display an estimated jewelry design to which a jewelry design, a jewelry main material, and a jewelry component selected through the customer terminal are applied in the jewelry design search window;
a 3D jewelry printer data storage configured to store 3D jewelry printer data used to 3D-print the estimated jewelry design to which the jewelry design, the jewelry main material, and the jewelry component selected through the customer terminal are applied;
a 3D jewelry printer data transmitter configured to transmit the 3D jewelry printer data to the 3D jewelry franchisee server selected by the customer, and
a design editor tool provider configured to provide a design editor tool through which a jewelry design is changeable to the customer terminal and provide an edited jewelry design obtained by combining zones selected by different jewelry designs to the customer terminal, and
wherein the search window generator includes a jewelry design selection field for selecting a jewelry design, a jewelry main material selection field for selecting a jewelry main material, and a jewelry component selection field for selecting a jewelry component, through a search operation, and the jewelry components provided in the jewelry design search window are allocated a standardized size per jewelry component.

2. The apparatus according to claim 1, wherein the search window generator displays 3D designs manufactured by designers, who have paid an advertisement fee, in an advertisement field of the jewelry design search window.

3. The apparatus according to claim 1, wherein the 3D jewelry printer data transmitter transmits the 3D jewelry printer data to the customer terminal.

4. The apparatus according to claim 1, wherein the 3D jewelry head office server further includes a cost settler configured to bill purchase costs of a jewelry design purchased by the customer and deposit some of the billed purchase costs in an account of a designer who has proposed a sold jewelry design.

5. The apparatus according to claim 1,
wherein the 3D jewelry printer data storage receives the edited jewelry design changed through the design editor tool from the customer terminal and generates and stores an edited 3D jewelry design file used to 3D-print the edited jewelry design, and
the 3D jewelry printer data transmitter transmits the edited 3D jewelry design file to the 3D jewelry franchisee server as the 3D jewelry printer data.

6. A method of selling 3D printed jewelry using the apparatus for selling 3D printed jewelry according to claim 1, the method comprising:
registering, by the designer terminal, jewelry designs, jewelry main materials, and jewelry components manufactured by designers in a 3D jewelry head office server;
providing, by the 3D jewelry head office server, a jewelry design search window for searching for the jewelry designs, jewelry main materials, and jewelry components registered by the designer terminal to a customer terminal;
selecting, by the customer terminal, a jewelry design, a jewelry main material, and a jewelry component to be purchased through the jewelry design search window and transmitting the selected design, main material, and component to the 3D jewelry head office server;
generating, by the 3D jewelry head office server, 3D jewelry printer data used to perform 3D printing of an estimated jewelry design to which the selected jewelry design, jewelry main material, and jewelry component are applied and storing the 3D jewelry printer data;
transmitting, by the 3D jewelry head office server, the 3D jewelry printer data to the 3D jewelry franchisee server corresponding to a server of a franchisee; and
manufacturing, by the 3D jewelry franchisee server, 3D jewelry by performing 3D printing according to the 3D jewelry printer data received from the 3D jewelry head office server.

7. The method according to claim 6, wherein the selecting includes:
confirming manufacturing by providing an estimated jewelry design to which the selected jewelry design, jewelry main material, and jewelry component are applied to the customer terminal; and
if manufacturing confirmation is acknowledged by the customer terminal, transmitting the selected jewelry design, jewelry main material, and jewelry component to the 3D jewelry head office server.

8. The method according to claim 6, wherein the providing further includes transmitting a design editor tool through which a jewelry design is changeable to the customer terminal.

9. The method according to claim 8,
wherein the selecting includes transmitting a jewelry design edited through the design editor tool to the 3D jewelry head office server,
wherein the storing includes receiving the jewelry design edited through the design editor tool from the customer terminal and storing an edited 3D jewelry design file used to 3D-print the edited jewelry design, and
wherein the transmitting the 3D jewelry printer data includes transmitting the edited 3D jewelry design file to the 3D jewelry franchisee server as the 3D jewelry printer data.
